(19) United States
(12) Patent Application Publication
(10) Pub. No.: US 2025/0006157 A1
(43) Pub. Date: Jan. 2, 2025

(54) PERCUSSION INSTRUMENT AND ROD TIGHTENING METHOD

(71) Applicant: Roland Corporation, Shizuoka (JP)

(72) Inventor: Ryoken Watanabe, Shizuoka (JP)

(73) Assignee: Roland Corporation, Shizuoka (JP)

(21) Appl. No.: 18/748,057

(22) Filed: Jun. 19, 2024

(30) Foreign Application Priority Data
Jun. 29, 2023 (JP) 2023-107123

(51) Int. Cl. G10D 13/10

(52) U.S. Cl. CPC G10D 13/28; G10D 13/26

(57) ABSTRACT

A percussion instrument includes a bracket including an insertion hole into which a horizontal rod is insertable and other insertion holes into which another horizontal rod is insertable. The horizontal rod inserted into the insertion hole may be tightened by a first tightening portion of a first tightening member, and the horizontal rod inserted into the other insertion holes may be tightened by a second tightening portion of a second tightening member. Thus, since a percussion instrument is supportable by the two horizontal rods that extend in the same direction (horizontal direction) and have different diameters, versatility may be improved.

### CROSS-REFERENCE TO RELATED APPLICATION

This application claims the priority benefit of Japan application serial no. 2023-107123, filed on Jun. 29, 2023. The entirety of the above-mentioned patent application is hereby incorporated by reference herein and made a part of this specification.

### BACKGROUND

### Technical Field

The disclosure relates to a percussion instrument and a rod tightening method, and more particularly to a percussion instrument and a rod tightening method that may improve versatility.

### Description of Related Art

A known technology is to support a percussion instrument on a rod by fixing the rod to a bracket provided on the outer surface of a housing. For example, Patent Document 1 (Japanese Patent Application Laid-Open (JP-A) No. 2010-286622 (e.g., paragraph 0020 and FIG. 1)) describes a drum bracket 100 capable of fixing a large diameter support rod 2 and a small diameter support rod 3 (rod) extending in a horizontal direction and a vertical direction. According to this technology, a percussion instrument may be supported on support rods 2 and 3 having different diameters and insertion directions.

However, the above-mentioned conventional technology has a problem in that it has low versatility because it can only fix rods of one diameter to the bracket in both the horizontal direction and vertical direction.

The disclosure provides a percussion instrument and a rod tightening method that may improve versatility.

### SUMMARY

The percussion instrument of the disclosure, which is supportable on a first rod and a second rod having a smaller diameter than the first rod, includes: a housing; a bracket, provided on an outer surface of the housing; a tightening bolt, tightened toward a cavity inside the bracket; and a tightening portion, elastically deformed or performing sliding displacement inside the bracket by a tightening force of the tightening bolt. The bracket includes a first insertion hole into which the first rod is insertable and a second insertion hole into which the second rod is insertable in a direction the same as an insertion direction of the first rod into the first insertion hole. The tightening portion is at least configured by a first tightening portion capable of tightening the first rod inserted into the first insertion hole and a second tightening portion capable of tightening the second rod inserted into the second insertion hole.

The rod tightening method of the disclosure is a method for tightening a rod in a percussion instrument, which is supportable on a first rod and a second rod having a smaller diameter than the first rod, and the percussion instrument includes: a housing; a bracket, provided on an outer surface of the housing; a tightening bolt, tightened toward a cavity inside the bracket; and a tightening portion, elastically deformed or performing sliding displacement inside the bracket by a tightening force of the tightening bolt. The bracket includes a first insertion hole into which the first rod is insertable and a second insertion hole into which the second rod is insertable in a direction the same as an insertion direction of the first rod into the first insertion hole. The tightening portion is at least configured by a first tightening portion and a second tightening portion, and the first rod inserted into the first insertion hole is tightened by the first tightening portion, while the second rod inserted into the second insertion hole is tightened by the second tightening portion.

### BRIEF DESCRIPTION OF THE DRAWINGS

FIG. 1A is a perspective view of the percussion instrument of the first embodiment, and FIG. 1B is a partially enlarged perspective view of the percussion instrument.

FIG. 2 is an exploded perspective view of the percussion instrument.

FIG. 3A is a partially enlarged cross-sectional view of the percussion instrument, and FIG. 3B is a partially enlarged cross-sectional view of the percussion instrument showing a state in which the horizontal rod is tightened by the first tightening portion.

FIG. 4A is a partially enlarged cross-sectional view of the percussion instrument showing a state in which the horizontal rod is tightened by the second tightening portion, and FIG. 4B is a partially enlarged cross-sectional view of the percussion instrument showing a state in which the vertical rod is tightened by the second tightening portion.

FIG. 5A is a partially enlarged cross-sectional view of the percussion instrument in part Va in FIG. 3B, and FIG. 5B is a partially enlarged cross-sectional view of the percussion instrument in part Vb in FIG. 4A.

FIG. 6A is a perspective view of the tightening member of the second embodiment, and FIG. 6B is a partially enlarged cross-sectional view of the percussion instrument of the second embodiment.

FIG. 7A is a partially enlarged cross-sectional view of the percussion instrument showing a state in which the horizontal rod is tightened by the first tightening portion, and FIG. 7B is a partially enlarged cross-sectional view of the percussion instrument showing a state in which the horizontal rod is tightened by the second tightening portion.

FIG. 8A is a perspective view of the back surface of the bracket of the third embodiment, and FIG. 8B is a cross-sectional view of the bracket.

FIG. 9A is a cross-sectional view of the bracket showing a state in which the horizontal rod is tightened by the first tightening portion, and FIG. 9B is a cross-sectional view of the bracket showing a state in which the horizontal rod is tightened by the second tightening portion.

FIG. 10A is a cross-sectional view of the bracket of the fourth embodiment, and FIG. 10B is a cross-sectional view of the bracket showing a state in which the horizontal rods are tightened by the first tightening portion and the second tightening portion.

FIG. 11A is a cross-sectional view of the bracket of the fifth embodiment, and FIG. 11B is a cross-sectional view of the bracket showing a state in which the horizontal rods are tightened by the first tightening portion and the second tightening portion.

FIG. 12A is a cross-sectional view of the bracket of the sixth embodiment, and FIG. 12B is a cross-sectional view of the bracket showing a state in which the horizontal rods are tightened by the first tightening portion and the second tightening portion.

### DESCRIPTION OF THE EMBODIMENTS

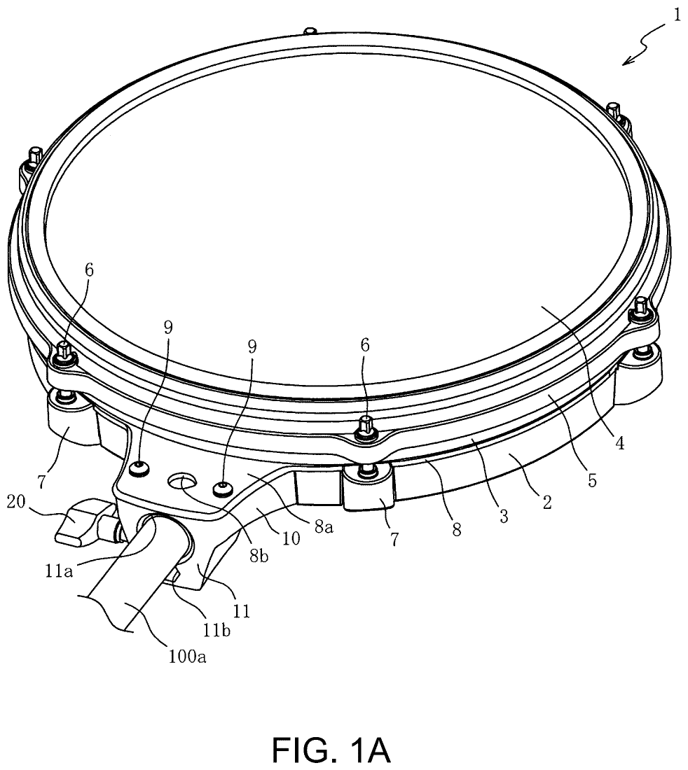

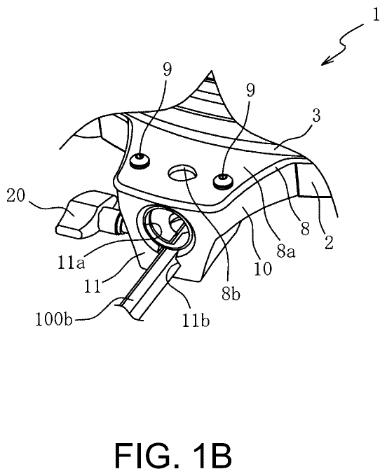

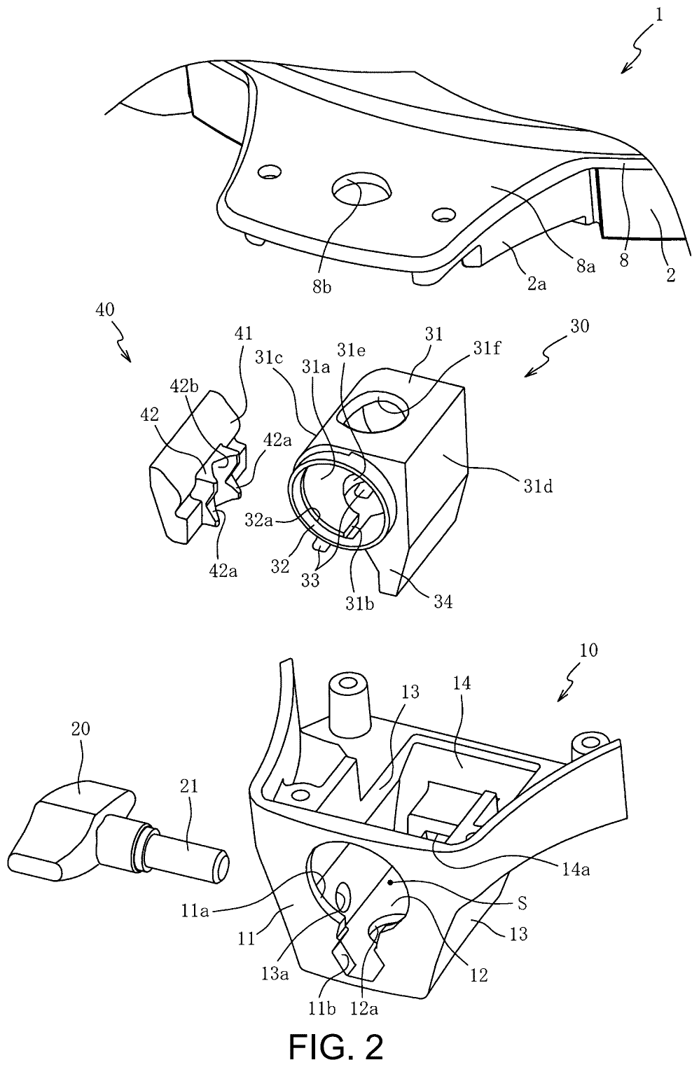

Exemplary embodiments of the disclosure will be described below with reference to the drawings. First, the overall configuration of the percussion instrument 1 of the first embodiment will be described with reference to FIG. 1A, FIG. 1B, and FIG. 2. FIG. 1A is a perspective view of the percussion instrument 1 of the first embodiment, and FIG. 1B is a partially enlarged perspective view of the percussion instrument 1. FIG. 2 is an exploded perspective view of the percussion instrument 1.

As shown in FIG. 1A and FIG. 1B, the percussion instrument 1 is an electronic percussion instrument that mimics an acoustic drum. The percussion instrument 1 includes a bottom frame 2 having a substantially disc shape that forms the bottom surface of the percussion instrument 1, and a top frame 3 that overlaps the bottom frame 2 and forms the outer circumferential surface of the percussion instrument 1 (housing) together with the bottom frame 2. Although not shown in the drawings, the top frame 3 is formed in a cylindrical shape, and the opening part on the upper end side of the top frame 3 is covered with a film-like head 4.

The head 4 is formed in a disc shape using a mesh made of woven synthetic fibers, and is attached to the percussion instrument 1 by a hoop 5 having an annular shape. The hoop 5 has through holes (not shown) formed at a plurality of positions in the circumferential direction of the hoop 5, and tension bolts 6 are inserted into these through holes. A plurality of lugs 7 are provided on the outer circumferential surface of the bottom frame 2, and tension is applied to the head 4 by tightening (screwing) the tension bolts 6 into the lugs 7 with the outer edge of the head 4 hooked onto the hoop 5.

A head sensor (not shown) that comes into contact with the lower surface of the head 4 is attached to the inner circumferential side of the top frame 3 (inside the housing formed by the bottom frame 2 and top frame 3), and when the head sensor detects vibrations when the head 4 (hitting surface) is hit, a musical tone signal based on the detection result is generated by a sound source (not shown). This musical tone signal is output to an amplifier and a speaker (neither of which are shown), and electronic musical tones are emitted from the speaker.

A reinforcement frame 8 formed in an annular shape using a metal plate is sandwiched between the bottom frame 2 and the top frame 3, and the reinforcement frame 8 is integrally formed with a protrusion 8a that protrudes toward the outer circumferential side of the bottom frame 2 and the top frame 3.

A bracket 10 is fixed (screwed) to the lower surface of the protrusion 8a by two fixing bolts 9 arranged in the circumferential direction. An outer circumferential wall 11 forming the outer circumferential surface of the bracket 10 has a circular insertion hole 11a for inserting a horizontal rod 100a and a polygonal (regular hexagonal in this embodiment) insertion hole 11b for inserting a horizontal rod 100b having a smaller diameter than the horizontal rod 100a formed in line in the up and down direction.

The horizontal rod 100a has a circular cross-sectional shape, and the horizontal rod 100b has a polygonal (regular hexagonal) cross-sectional shape. The diameter of the horizontal rod 100b (the diameter of a circle circumscribing the polygonal horizontal rod 100b) is formed to be smaller than the diameter of the horizontal rod 100a. Similarly, the diameter of the insertion hole 11b (the diameter of a circle circumscribing each vertex of the polygonal insertion hole 11b) is formed to be smaller than the diameter of the insertion hole 11a.

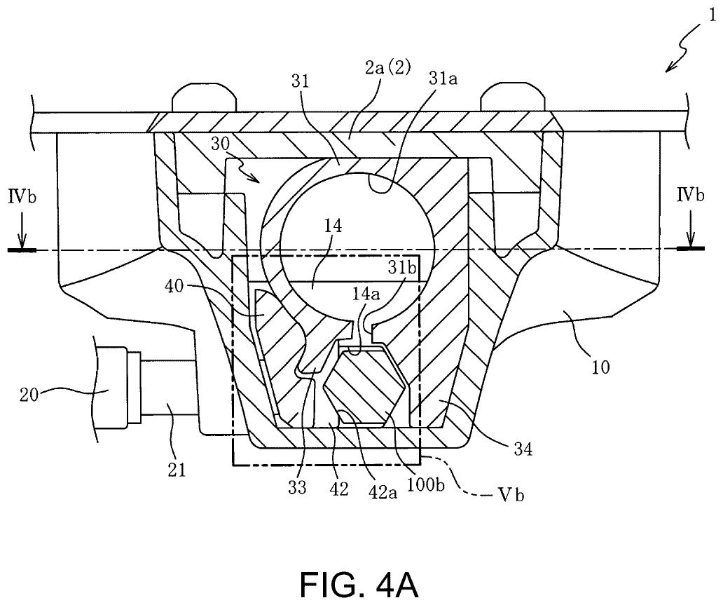

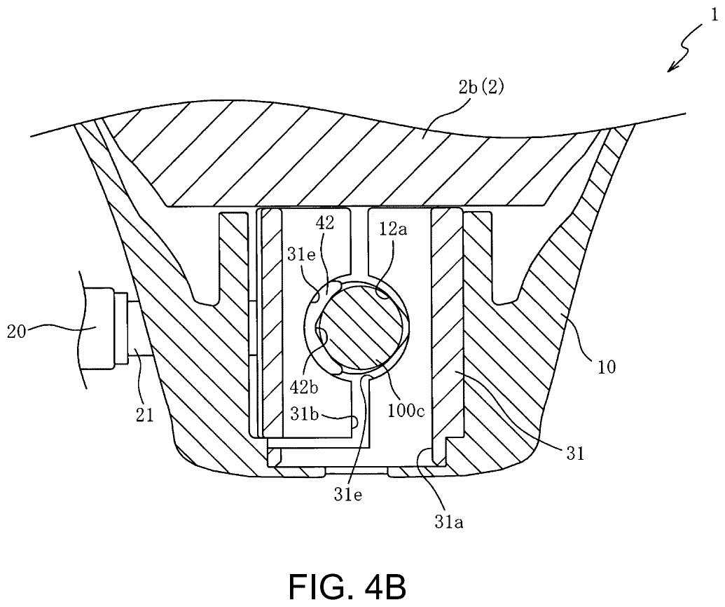

An insertion hole 8b penetrating through upward and downward is formed in the protrusion 8a of the reinforcement frame 8, and this insertion hole 8b is a hole for inserting a vertical rod 100c (see FIG. 4B) extending in the vertical direction.

These horizontal rods 100a and 100b and vertical rod 100c are all rods that form a part of a drum set (drum stand) and support the percussion instrument 1. Depending on the type of drum set supporting the percussion instrument 1, either a horizontal rod 100a, a horizontal rod 100b, or a vertical rod 100c is (selectively) fixed to the bracket 10.

Each of the rods 100a to 100c is fixed to the bracket 10 by a tightening bolt 20. The tightening bolt 20 is tightened to the bracket 10 in a horizontal direction perpendicular to the insertion direction of the horizontal rod 100b into the insertion hole 11b and the insertion direction of the vertical rod 100c into the insertion hole 8b (hereinafter referred to as “the tightening direction of the tightening bolt 20.”).

As shown in FIG. 1A, FIG. 1B, and FIG. 2, the bracket 10 includes a bottom wall 12 (see FIG. 2) extending from a lower end of the outer circumferential wall 11 to the bottom frame 2 side (an inner circumferential side of the percussion instrument 1), and a pair of side walls 13 rise upward from two ends of the bottom wall 12 in the tightening direction of the tightening bolt 20. A pair of side walls 13 are connected by an inner circumferential wall 14 in the tightening direction of the tightening bolt 20, and each wall 11 to 14 of the bracket 10 is integrally formed by using a metal.

In the bracket 10, a cavity S surrounded by the walls 11 to 14 is formed, and a first tightening member 30 and a second tightening member 40 are housed in the cavity S through an opening part in the upper side. The bracket 10 with each of the tightening members 30, 40 housed therein is screwed to the protrusion 8a of the reinforcement frame 8 using the fixing bolts 9 (see FIG. 1A and FIG. 1B), so that the bracket 10 and each of the tightening members 30, 40 are assembled to the percussion instrument 1.

The first tightening member 30 is a resin part for tightening the horizontal rod 100a (see FIG. 1A), and the second tightening member 40 is a metal part for tightening the horizontal rod 100b (see FIG. 1B).

The first tightening member 30 includes a cylindrical first tightening portion 31 having an inner circumferential surface 31a with a circular cross section, and an annular portion 32 is integrally formed on an end surface of the first tightening portion 31 in the axial direction. The annular portion 32 is a protrusion of an annular shape having the same inner diameter as the inner circumferential surface 31a of the first tightening portion 31, and the outer diameter of the annular portion 32 is formed to be the same as (or slightly smaller than) the inner diameter of the insertion hole 11a. When the annular portion 32 is fitted into the insertion hole 11a of the bracket 10, the inner circumferential surface 31a of the first tightening portion 31 communicates with the insertion hole 11a.

Thus, when the horizontal rod 100a is inserted through the insertion hole 11a, the horizontal rod 100a is held by the inner circumferential surface 31a of the first tightening portion 31. Although not shown in the drawings, the insertion of the horizontal rod 100a toward the inner circumferential surface 31a of the first tightening portion 31 is stopped by contact with a regulating wall 2b of the bottom frame 2 (see FIG. 4B).

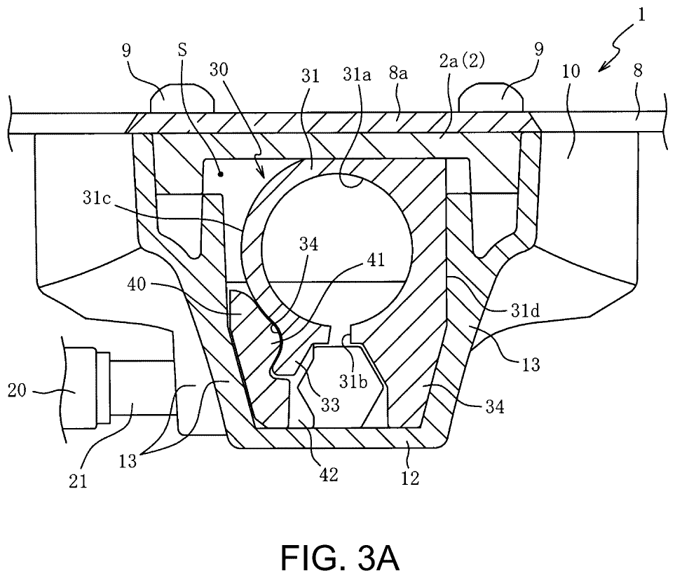

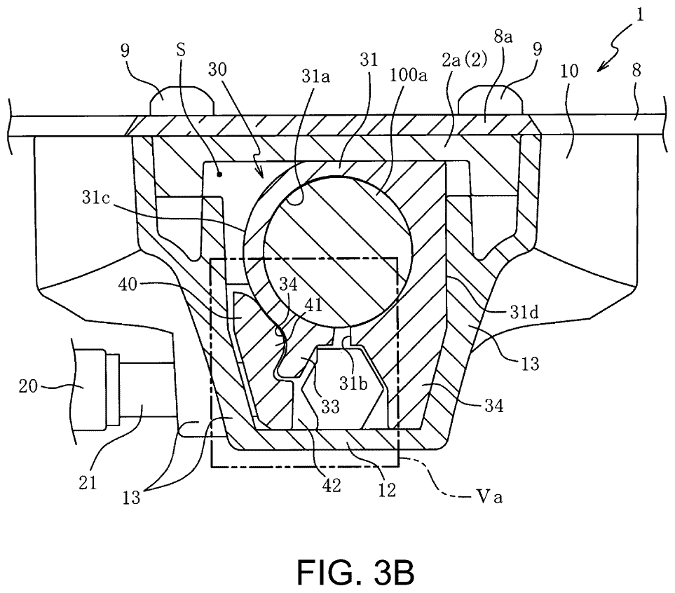

First, the structure for tightening the horizontal rod 100a with the first tightening portion 31 will be described with reference to FIG. 2, FIG. 3A, and FIG. 3B. FIG. 3A is a partially enlarged cross-sectional view of the percussion instrument 1, and FIG. 3B is a partially enlarged cross-sectional view of the percussion instrument 1 showing a state in which the horizontal rod 100a is tightened by the first tightening portion 31. In addition, FIG. 3A and FIG. 3B shows a cross section cut along a plane perpendicular to the insertion direction of the horizontal rod 100a, which shows a cross section including a protrusion 33 located on the insertion hole 11a side among the pair of protrusions 33 (see FIG. 2) of the first tightening member 30.

As shown in FIG. 2, FIG. 3A, and FIG. 3B, a slit 31b is formed in the lower end portion of the first tightening portion 31, partially dividing the first tightening portion 31 in a circumferential direction (the direction around the inner circumferential surface 31a). The slit 31b is a crack extending across two ends in the axial direction of the inner circumferential surface 31a of the first tightening portion 31, and one end of the slit 31b in the longitudinal direction (the end on the insertion hole 11a side) is connected to a slit 32a (see FIG. 2). The slit 32a is formed by cutting out the base part of the annular portion 32 (the part connected to the first tightening portion 31) over approximately half the circumference. The formation of these slits 31b and 32a enables the first tightening portion 31 formed in a substantially C-shape to be elastically deformed (deformed to narrow the width of the slit 31b).

A side surface 31c of the first tightening portion 31 facing the tightening bolt 20 side (left side in FIG. 3A and FIG. 3B) is formed in an arc shape corresponding to the inner circumferential surface 31a of the first tightening portion 31 (centered on the central axis of the inner circumferential surface 31a), and the protrusion 33 is integrally formed at the lower end portion (near the slit 31b) of the side surface 31c of the first tightening portion 31.

A recessed portion 34 (see FIG. 3A and FIG. 3B) is formed at the connection between the base of the protrusion 33 and the side surface 31c of the first tightening portion 31, and the recessed portion 34 is formed in a groove shape extending across two ends of the protrusion 33 in the insertion direction of the horizontal rod 100a (the direction perpendicular to the paper surface of FIG. 3A and FIG. 3B). The bottom surface of the recessed portion 34 (the surface facing the tightening bolt 20) is curved to be projecting toward the opposite side to the tightening bolt 20 (the right side in FIG. 3A and FIG. 3B), and a projecting portion 41 of the second tightening member 40 is fitted into this recessed portion 34. The projecting portion 41 has a curved shape along the recessed portion 34 (projecting toward the recessed portion 34 side).

Each of the tightening members 30 and 40 is housed in the cavity S of the bracket 10 with the projecting portion 41 fitted into the recessed portion 34. In this housed state, the displacement of the first tightening member 30 in each direction is regulated by the bottom frame 2 and the bracket 10.

Specifically, the displacement of the first tightening member 30 in the insertion direction of the horizontal rod 100a (the direction perpendicular to the paper surface of FIG. 3A and FIG. 3B) is regulated by the outer circumferential wall 11 of the bracket 10 (see FIG. 2) and the above-mentioned regulating wall 2b of the bottom frame 2 (see FIG. 4B).

In addition, a leg portion 34 is integrally formed on a side surface 31d of the first tightening portion 31 facing the opposite side to the tightening bolt 20 (the right side in FIG. 3A and FIG. 3B) and is continuing to the side surface 31d, and the leg portion 34 protrudes downward from the slit 31b and is supported by the bottom wall 12 of the bracket 10. The bottom frame 2 also includes a protrusion 2a sandwiched between the reinforcement frame 8 (protrusion 8a) and the bracket 10, and the first tightening member 30 is covered from above by this protrusion 2a. Thus, the up and down displacement of the first tightening member 30 is regulated by the protrusion 2a of the bottom frame 2 and the bottom wall 12 of the bracket 10.

A female screw hole 13a (see FIG. 2) is formed in the side wall 13 of the pair of side walls 13 of the bracket 10 on the opposite side from the leg portion 34, and a shaft portion 21 of the tightening bolt 20 is tightened to this female screw hole 13a. Since the second tightening member 40 is provided on the tip side of the shaft portion 21 of this tightening bolt 20, the tightening force when the tightening bolt 20 is tightened acts on the second tightening member 40.

Due to the tightening force of the tightening bolt 20, the second tightening member 40 undergoes sliding displacement along the tightening direction of the tightening bolt 20, and as a result of this sliding displacement, the protrusion 33 (recessed portion 34) of the first tightening member 30 is pushed into the projecting portion 41 of the second tightening member 40 (see FIG. 3B). As the protrusion 33 of the first tightening member 30 is pushed in, the first tightening portion 31 is elastically deformed so as to reduce the diameter of the inner circumferential surface 31a thereof (to narrow the width of the slit 31b), and the horizontal rod 100a is tightened. As a result, the horizontal rod 100a is fixed to the bracket 10.

Next, a configuration for tightening the horizontal rod 100b and the vertical rod 100c will be described with reference to FIG. 2 and FIG. 4A and FIG. 4B. FIG. 4A is a partially enlarged cross-sectional view of the percussion instrument 1 showing a state in which the horizontal rod 100b is tightened by the second tightening portion 42 of the second tightening member 40, and FIG. 4B is a partially enlarged cross-sectional view of the percussion instrument 1 showing a state in which the vertical rod 100c is tightened by the second tightening portion 42 of the second tightening member 40. It is noted that FIG. 4B corresponds to a cross section taken along line IVb-IVb in FIG. 4A. First, a configuration for tightening the horizontal rod 100b will be described with reference to FIG. 2 and FIG. 4A.

As shown in FIG. 2 and FIG. 4A, an insertion hole 14a is formed in the inner circumferential wall 14 of the bracket 10, and this insertion hole 14a faces the insertion hole 11b (see FIG. 2) in the insertion direction of the horizontal rod 100b. Further, the protrusion 33 and the leg portion 34 of the first tightening member 30 are formed on two sides of the insertion hole 14a (positions avoiding the insertion hole 14a) when viewed in the insertion direction of the horizontal rod 100b (see FIG. 4A). Thus, the horizontal rod 100b inserted from the insertion hole 11b (see FIG. 2) passes between the protrusion 33 and the leg portion 34 of the first tightening member 30 and is inserted into the insertion hole 14a.

A pair of protrusions 33 are formed (see FIG. 2) in line in the insertion direction of the horizontal rod 100a (the direction perpendicular to the paper surface of FIG. 4A), and the second tightening portion 42 of the second tightening member 40 is inserted between the pair of protrusions 33. The second tightening portion 42 is a protrusion formed integrally with the projecting portion 41 of the second tightening member 40, and the second tightening portion 42 is formed in a substantially central part of the projecting portion 41 in the insertion direction of the horizontal rod 100a (see FIG. 2).

A groove 42a for tightening the horizontal rod 100b is formed at the tip of the second tightening portion 42 (the right end portion in FIG. 4A). The groove 42a is formed in a V-shape recessed in a direction away from the central axis of the insertion hole 14a when viewed in the insertion direction of the horizontal rod 100b.

The groove 42a is formed at a position that protrudes further toward the center side of the insertion hole 14a than the protrusion 33 when viewed in the insertion direction of the horizontal rod 100b (see FIG. 4A). Thus, by tightening the tightening bolt 20 with the horizontal rod 100b inserted into the insertion hole 14a, the groove 42a of the second tightening portion 42 pushes the horizontal rod 100b against the inner circumferential surface of the insertion hole 14a. At this time, although not shown in the drawings, the horizontal rod 100b is also pushed against the inner circumferential surface of the insertion hole 11b (see FIG. 2). That is, the horizontal rod 100b is fixed to the bracket 10 by being sandwiched between the groove 42a of the second tightening portion 42 and the insertion holes 11b and 14a.

Next, a configuration for tightening the vertical rod 100c will be described with reference to FIG. 2 and FIG. 4A. An insertion hole 12a for inserting the vertical rod 100c is formed in the bottom wall 12 of the bracket 10 (see FIG. 2), and a pair of through holes 31e and 31f are formed at positions overlapping the insertion hole 12a in the up and down direction in the first tightening portion 31 of the first tightening member 30. The through hole 31e is a hole that connects the lower surface of the first tightening portion 31 to the inner circumferential surface 31a, and the through hole 31f is a hole that connects the upper surface of the first tightening portion 31 to the inner circumferential surface 31a.

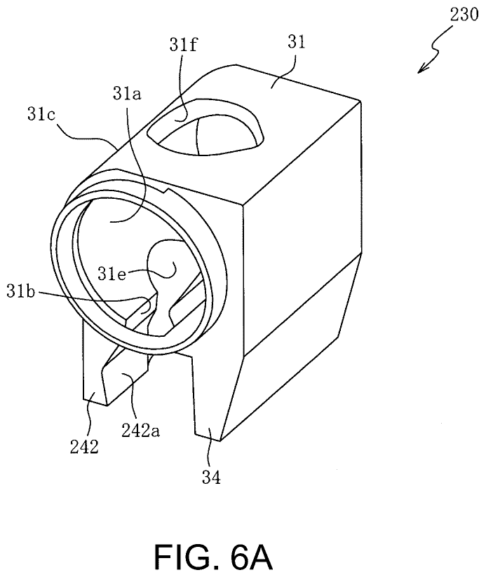

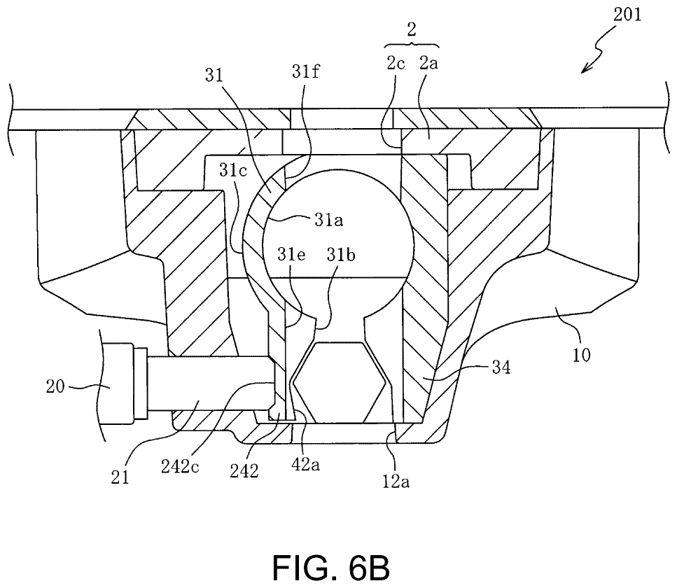

It is noted that, although not shown in the drawings, a through hole 2c is also formed in the protrusion 2a of the bottom frame 2 that covers the first tightening portion 31 from above (see FIG. 6B). Thus, the vertical rod 100c (see FIG. 4B) inserted from below the insertion hole 12a is inserted into the insertion hole 8b of the reinforcement frame 8 through the through holes 31e and 31f (see FIG. 2) of the first tightening member 30. The inserted state of the vertical rod 100c is also fixed by the second tightening member 40.

A groove 42b for tightening the vertical rod 100c is formed at the tip of the second tightening portion 42 of the second tightening member 40. The groove 42b is formed in a V-shape recessed in a direction away from the central axis of the insertion hole 12a when viewed in the insertion direction of the vertical rod 100c (see FIG. 4B). It is noted that, the depth of the groove 42b from the tip of second tightening portion 42 is formed deeper than the groove 42a (see FIG. 2), and a pair of grooves 42a are formed on two sides of the groove 42b (separated from each other in the insertion direction of the horizontal rod 100b).

The groove 42b of the second tightening portion 42 is formed at a position that protrudes further toward the center side of the insertion hole 12a than the through hole 31e of the first tightening portion 31 when viewed in the insertion direction of the vertical rod 100c (see FIG. 4B). Thus, by tightening the tightening bolt 20 with the vertical rod 100c inserted into each of the insertion holes 8b and 12a (through holes 31e and 31f), the groove 42b of the second tightening portion 42 pushes the vertical rod 100c against the inner circumferential surface of the insertion hole 12a. At this time, although not shown in the drawings, the vertical rod 100c is also pushed against the inner circumferential surface of the insertion hole 8b (see FIG. 2). That is, the vertical rod 100c is fixed to the bracket 10 by being sandwiched between the groove 42b of the second tightening portion 42 and the insertion holes 8b and 12a.

In this way, in this embodiment, the horizontal rod 100a inserted into the insertion hole 11a (first tightening portion 31) is capable to be tightened by the first tightening portion 31 of the first tightening member 30 (see FIG. 3B), and the horizontal rod 100b inserted into the insertion holes 11b and 14a is capable to be tightened by the second tightening portion 42 (groove 42a) of the second tightening member 40 (see FIG. 4A). As a result, the percussion instrument 1 may be supported by two horizontal rods 100a and 100b that extend in the same direction (horizontal direction) and have different diameters, thereby improving versatility.

Furthermore, the vertical rod 100c extending in a direction different from the horizontal rods 100a and 100b may also be tightened by the groove 42b of the second tightening portion 42. Thus, the versatility of the percussion instrument 1 may be further improved.

In addition, since the horizontal rod 100a is tightened by utilizing the elastic deformation of the first tightening portion 31, by loosening the tightening bolt 20, the elastic restoring force of the first tightening portion 31 may be utilized to return each of the tightening members 30 and 40 to their initial positions (the state before the tightening bolt 20 is tightened). Thus, the tightening portions 31 and 42 may be suppressed from interfering with (getting caught on) the insertion of each of the rods 100a to 100c, thereby improving the workability when the percussion instrument 1 is supported by the rods 100a to 100c.

Here, a configuration in which a second tightening portion 242 is integrally formed with a tightening member 230 may also be adopted, as in the second embodiment described later (see FIG. 6A and FIG. 6B). However, in this configuration, when the second tightening portion 242 is pushed in by the tightening bolt 20, the first tightening portion 31 is deformed such that the second tightening portion 242 rotates with the upper end portion of the first tightening portion 31 being the center. Thus, the second tightening portion 242 is not able to be displaced along the tightening direction of the tightening bolt 20.

In contrast, in this embodiment, the first tightening member 30 having the first tightening portion 31 and the second tightening member 40 having the second tightening portion 42 are separate parts, and in this configuration, the first tightening portion 31 is elastically deformed by utilizing the sliding displacement of the second tightening member 40 caused by the tightening force of the tightening bolt 20.

With this configuration, unlike the case where the second tightening portion 242 is integrally formed with the tightening member 230 as in the above-mentioned second embodiment, the second tightening portion 42 may be suppressed from accompanying the elastic deformation of the first tightening portion 31. As a result, the second tightening portion 42 (second tightening member 40) becomes more easily displaced along the tightening direction of the tightening bolt 20, so that the tightening force of the tightening bolt 20 is more easily transmitted to the horizontal rod 100b and the vertical rod 100c. Thus, each of the rods 100b and 100c may be firmly fixed to the bracket 10.

In addition, since the grooves 42a and 42b of the second tightening portion 42 are formed at positions overlapping the shaft portion 21 of the tightening bolt 20 in the tightening direction of the tightening bolt 20, the tightening force of the tightening bolt 20 is easily transmitted to the horizontal rod 100b and the vertical rod 100c. Thus, each of the rods 100b and 100c may be firmly fixed to the bracket 10.

In addition, the protrusion 33 protrudes from the outer circumferential surface (near the slit 31b) of the first tightening portion 31, and since the protrusion 33 formed on the displacement locus of the second tightening member 40 is pushed in by the second tightening member 40, the first tightening portion 31 is more easily elastically deformed. This is because, when the first tightening portion 31 is elastically deformed starting from the upper end portion thereof, the first tightening portion 31 may be pushed in at a position away from the starting point of the elastic deformation.

In addition, a pair of protrusions 33 are formed in line in the insertion direction of the horizontal rod 100b (horizontal rod 100a), and the second tightening portion 42 is configured to tighten the horizontal rod 100b with the second tightening portion 42 protruding from between the pair of protrusions 33. As a result, the tightening position of the horizontal rod 100a by the first tightening portion 31 and the tightening position by the second tightening portion 42 may be brought closer to each other. Thus, the distance between the insertion holes 11a and 11b (see FIG. 2) may be made small, and the bracket 10 may be made compact.

Here, in this embodiment, the leg portion 34 is formed extending downward from the first tightening portion 31, and the second tightening portion 42 (grooves 42a and 42b) and the leg portion 34 face each other in the tightening direction of the tightening bolt 20. Thus, for example, each of the rods 100b and 100c may be tightened by the second tightening portion 42 and the leg portion 34. However, in such a configuration, since each of the rods 100b and 100c is tightened at one point (approximately one point) in the longitudinal direction, each of the rods 100b and 100c may not be firmly fixed to the bracket 10.

In contrast, in this embodiment, the horizontal rod 100b is fixed to the bracket 10 by being sandwiched at multiple points between the groove 42a of the second tightening portion 42 and the edges of the two insertion holes 11b and 14a. Similarly, the vertical rod 100c is fixed to the bracket 10 by being sandwiched at multiple points between the groove 42b of the second tightening portion 42 and the edges of the two insertion holes 8b and 12a. In this way, by tightening each of the rods 100b and 100c at multiple points in the longitudinal direction, each of the rods 100b and 100c may be firmly fixed to the bracket 10.

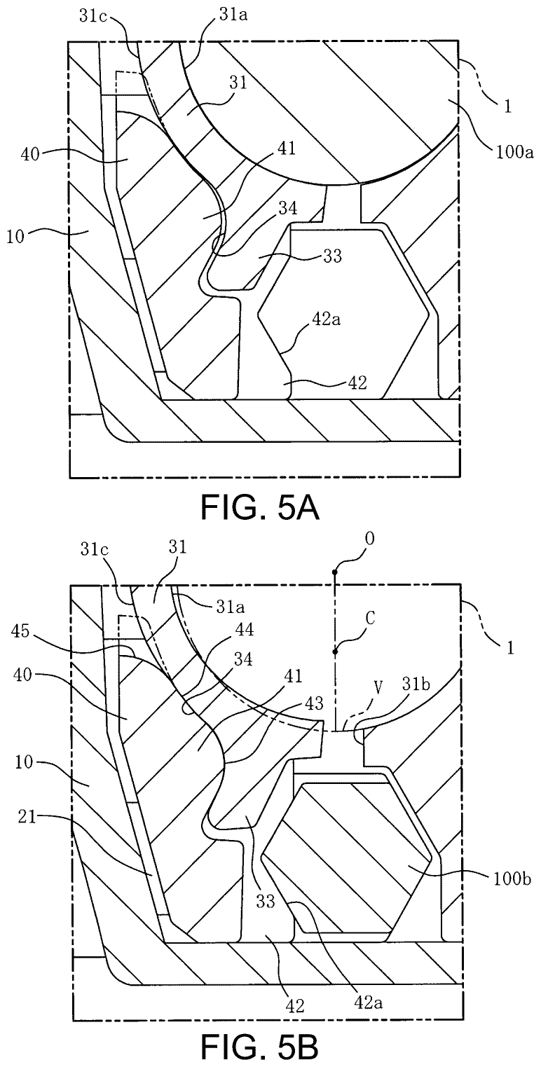

Next, the configuration of the second tightening member 40 will be further described with reference to FIG. 5A and FIG. 5B. FIG. 5A is a partially enlarged cross-sectional view of the percussion instrument 1 in part Va in FIG. 3B, and FIG. 5B is a partially enlarged cross-sectional view of the percussion instrument 1 in part Vb in FIG. 4A.

As shown in FIG. 5A, when the protrusion 33 is pushed in by the projecting portion 41 with the horizontal rod 100a inserted into the first tightening portion 31, after the first tightening portion 31 is elastically deformed to a certain extent, the elastic deformation is regulated by contact with the horizontal rod 100a. That is, when the horizontal rod 100a is tightened by the first tightening portion 31, the inner circumferential surface 31a of the first tightening portion 31 holds a substantially circular shape.

On the other hand, as shown in FIG. 5B, when the horizontal rod 100b is tightened by the second tightening portion 42, the horizontal rod 100a is not present on the inner circumferential side of the first tightening portion 31. Thus, when the protrusion 33 is pushed in by the projecting portion 41, the first tightening portion 31 is easily deformed so as to be pushed up by the projecting portion 41.

As a result, for example, as shown by the two-dot chain line in FIG. 5B, in the case where the contact area between the second tightening member 40 and the side surface 31c of the first tightening portion 31 is increased in the up and down direction, when the projecting portion 41 slides while pushing up the first tightening portion 31, the side surface 31c of the first tightening portion 31 is likely to interfere with the upper edge of the second tightening member 40. When this interference causes the second tightening member 40 to tilt (rotate counterclockwise in FIG. 5B), the second tightening portion 42 (groove 42a) is not able to appropriately tighten the horizontal rod 100b. A configuration for solving this problem will be described below.

The second tightening member 40 is formed with a projecting surface 43 forming the tip surface of the projecting portion 41, a recessed surface 44 continuing to the upper edge of the projecting surface 43, and a flank surface 45 continuing to the upper edge of the recessed surface 44. The projecting surface 43 is formed in a projecting arc shape toward the recessed portion 34 side of the first tightening portion 31, and the curvature of the projecting surface 43 is the same as that of the recessed portion 34. Further, the recessed surface 44 is formed in a projecting arc shape in a direction away from the side surface 31c of the first tightening portion 31, and the curvature of the recessed surface 44 is the same as that of the side surface 31c of the first tightening portion 31.

Then, the flank surface 45 continuing to the upper edge of the recessed surface 44 is formed in an upwardly projecting arc shape, and by forming such a flank surface 45 on the upper end part of the second tightening member 40, the contact area between the second tightening member 40 and the side surface 31c of the first tightening portion 31 may be reduced. More specifically, when a virtual circle V is drawn centered on the central axis O of the inner circumferential surface 31a of the first tightening portion 31, the second tightening member 40 is in contact with the side surface 31c of the first tightening portion 31 below the center C of the line segment connecting the lower end of the virtual circle V (the center of the slit 31b in the circumferential direction of the inner circumferential surface 31a) and the central axis O.

As a result, the side surface 31c of the first tightening portion 31 is suppressed from interfering with the upper edge of the second tightening member 40 when the second tightening member 40 slides while pushing up the first tightening portion 31. As a result, the second tightening portion 42 (groove 42a) is suppressed from being tilted, so that the horizontal rod 100b may be appropriately tightened. Thus, the horizontal rod 100b may be firmly fixed to the bracket 10.

It is noted that in this embodiment, the flank surface 45 is formed to be continuous with the upper edge of the recessed surface 44, but this is not necessarily limited thereto. For example, the recessed surface 44 may be omitted, and the flank surface 45 may be formed to be continuous with the upper edge of the projecting surface 43. In this way, the side surface 31c of the first tightening portion 31 may also be suppressed from interfering with the upper edge of the second tightening member 40 when the second tightening member 40 slides while pushing up the first tightening portion 31.

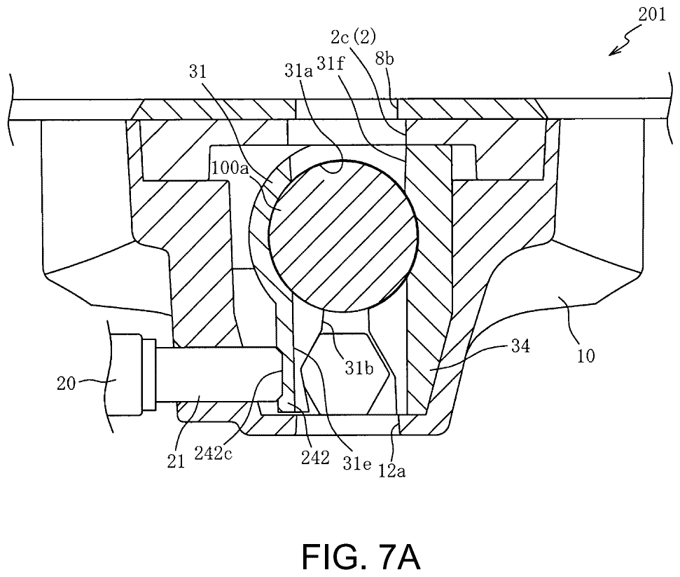

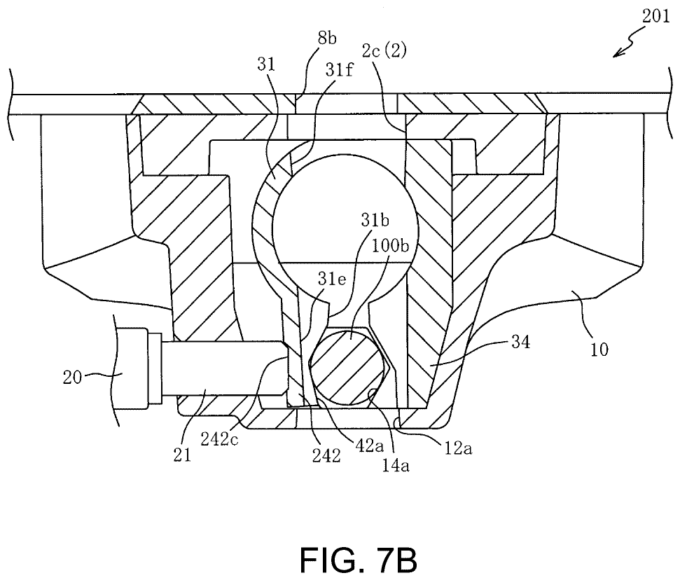

Next, the percussion instrument 201 of the second embodiment will be described with reference to FIG. 6A, FIG. 6B, FIG. 7A, and FIG. 7B. It is noted that the same parts as those in the above-mentioned first embodiment are denoted by the same reference numerals, and the description thereof will be omitted.

FIG. 6A is a perspective view of the tightening member 230 of the second embodiment, and FIG. 6B is a partially enlarged cross-sectional view of the percussion instrument 201 of the second embodiment. FIG. 7A is a partially enlarged cross-sectional view of the percussion instrument 201 showing a state in which the horizontal rod 100a is tightened by the first tightening portion 31, and FIG. 7B is a partially enlarged cross-sectional view of the percussion instrument 201 showing a state in which the horizontal rod 100b is tightened by the groove 42a of the second tightening portion 242. It is noted that FIG. 6B, FIG. 7A, and FIG. 7B show cross sections cut along a plane that includes the shaft portion 21 of the tightening bolt 20 and is perpendicular to the insertion direction of the horizontal rods 100a and 100b.

As shown in FIG. 6A and FIG. 6B, the tightening member 230 of the percussion instrument 201 of the second embodiment has the same configuration as the first tightening member 30 of the first embodiment, except for the point that the protrusions 33 (see FIG. 2) are omitted and the point that the first tightening portion 31 and the second tightening portion 242 are integrally formed.

The second tightening portion 242 extends downward so as to be continuous with the side surface 31c of the first tightening portion 31, and a recessed portion 242c into which the shaft portion 21 is fitted is formed on the side surface of the second tightening portion 242 facing the tightening bolt 20. Thus, when the second tightening portion 242 is pushed in by the tightening force of the tightening bolt 20, the first tightening portion 31 is elastically deformed so as to reduce the diameter of the inner circumferential surface 31a.

Thus, as shown in FIG. 7A, by tightening the tightening bolt 20 with the horizontal rod 100a inserted into the first tightening portion 31, the horizontal rod 100a is tightened by the first tightening portion 31 which is elastically deformed along with the second tightening portion 242.

As shown in FIG. 7B, when viewed in the insertion direction of the horizontal rod 100b, the second tightening portion 242 and the leg portion 34 face each other across the insertion hole 14a, and the groove 42a is formed on the side surface of the second tightening portion 242 facing the leg portion 34. Thus, by tightening the tightening bolt 20 with the horizontal rod 100b inserted into the insertion hole 14a, the horizontal rod 100b is tightened by the groove 42a of the second tightening portion 242.

Further, the through hole 31e for inserting the vertical rod 100c (see FIG. 4B) extends upward and downward so as to be continuous with the second tightening portion 242. Thus, although not shown in the drawings, the vertical rod 100c inserted into the insertion hole 8b through the insertion hole 12a and the through holes 31e, 31f, and 2c is fixed to the bracket 10 by being sandwiched at multiple points between the second tightening portion 242 (the inner circumferential surface of the through hole 31e) and the edges of the two insertion holes 8b and 12a.

In this way, also in this embodiment, the horizontal rods 100a and 100b and the vertical rod 100c may be tightened by the first tightening portion 31 and the second tightening portion 242 of the tightening member 230. As a result, the percussion instrument 201 may be supported by the two horizontal rods 100a and 100b that extend in the same direction (horizontal direction) and have different diameters, while the percussion instrument 201 may also be supported by the vertical rod 100c that extends in a direction different from that of the horizontal rods 100a and 100b. Thus, the versatility of the percussion instrument 201 may be improved.

Further, the tightening member 230 is integrally formed with the first tightening portion 31 for tightening the horizontal rod 100a and the second tightening portion 242 for tightening the horizontal rod 100b. As a result, the number of parts may be reduce compared to the above-mentioned first embodiment in which the first tightening member 30 (first tightening portion 31) and the second tightening member 40 (second tightening portion 42) are separate, and the work of assembling the bracket 10 and the tightening member 230 to the percussion instrument 201 may be facilitated.

It is noted that, although the horizontal rod 100b of this embodiment is formed into a columnar shape having a smaller diameter than the horizontal rod 100a, it is of course possible to tighten the polygonal horizontal rod 100b similar to the first embodiment using the second tightening portion 242 (groove 42a) (the same applies to the third to sixth embodiments described later).

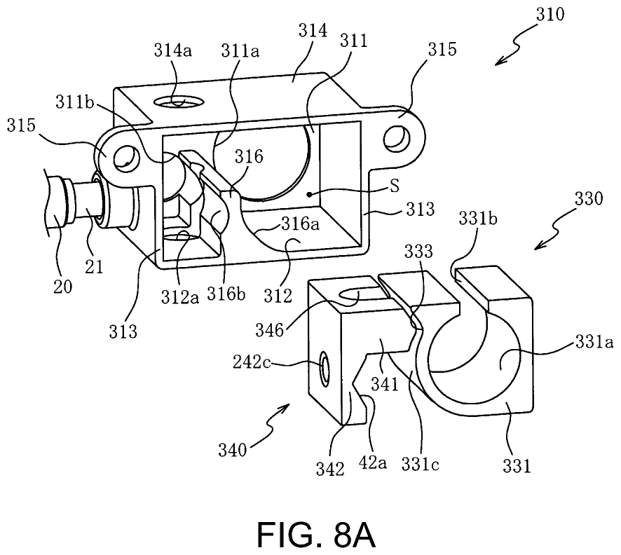

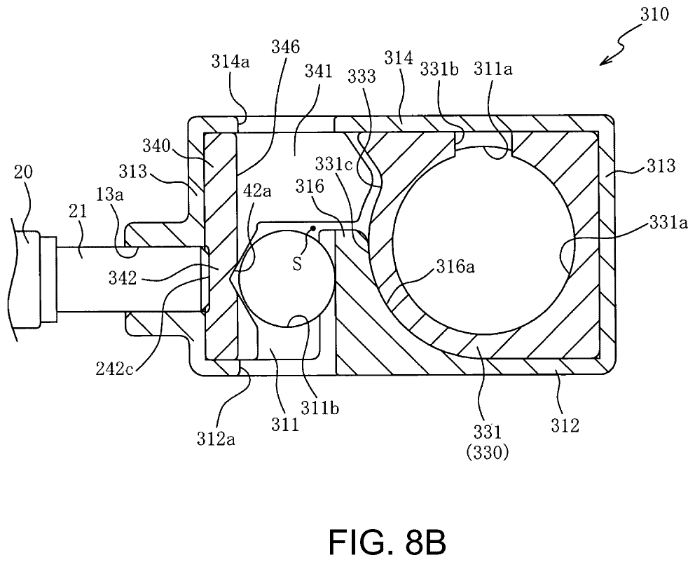

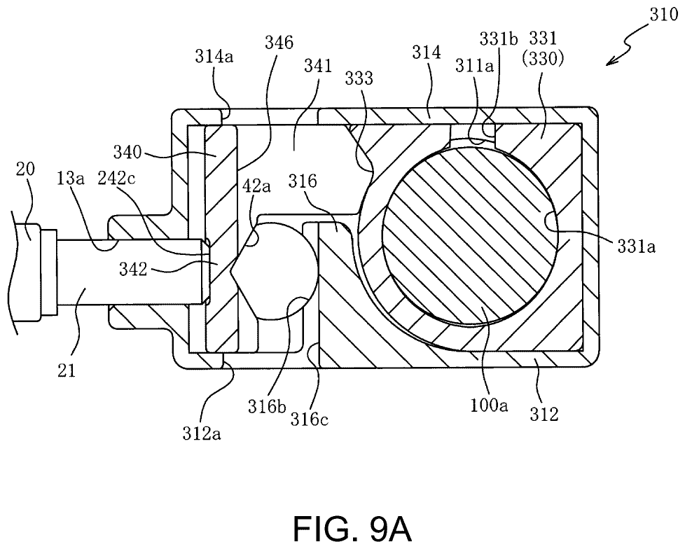

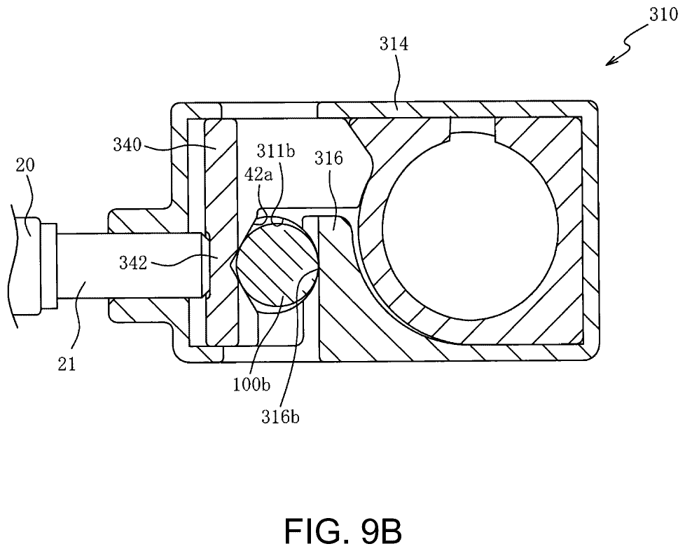

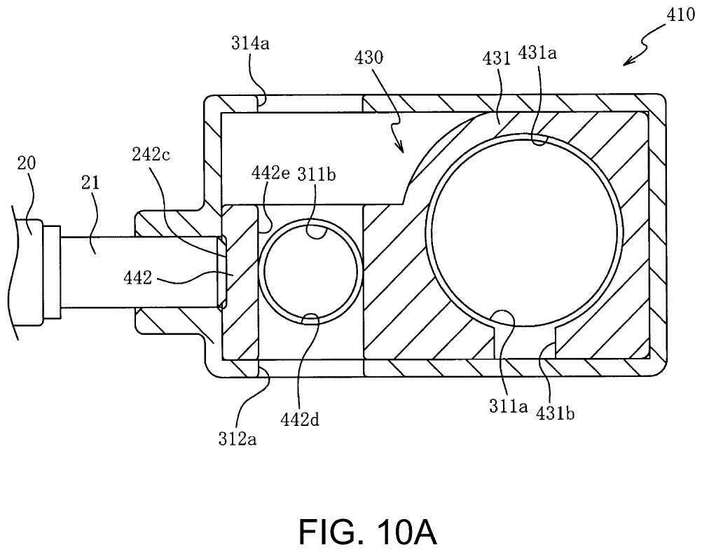

Next, the bracket 310 of the third embodiment will be described with reference to FIG. 8A, FIG. 8B, FIG. 9A, and FIG. 9B. It is noted that the same parts as those in each of the above-mentioned embodiments are denoted by the same reference numerals, and the description thereof will be omitted. FIG. 8A is a perspective view of the back surface of the bracket 310 of the third embodiment, and FIG. 8B is a cross-sectional view of the bracket 310. FIG. 9A is a cross-sectional view of the bracket 310 showing a state in which the horizontal rod 100a is tightened by the first tightening portion 331, and FIG. 9B is a cross-sectional view of the bracket 310 showing a state in which the horizontal rod 100b is tightened by the second tightening portion 342.

As shown in FIG. 8A and FIG. 8B, the bracket 310 of the third embodiment is formed in a box shape having an opening on the side of the housing (not shown) of the percussion instrument. More specifically, an outer circumferential wall 311 of the bracket 310 is provided with circular insertion holes 311a and 311b for inserting the horizontal rods 100a and 100b (see FIG. 9A and FIG. 9B). These insertion holes 311a and 311b are formed in line in the tightening direction of the tightening bolt 20 (the left and right direction in FIG. 8B).

A lower wall 312 extends from the lower end of the outer circumferential wall 311 toward the housing side of the percussion instrument (the front side of the direction perpendicular to the paper surface of FIG. 8A and FIG. 8B), and a pair of side walls 313 extend upward from two ends of the lower wall 312 in the tightening direction of the tightening bolt 20 (the left and right direction in FIG. 8B). The upper ends of the pair of side walls 313 are connected to each other by an upper wall 314, and the lower wall 312 and the upper wall 314 are provided with insertion holes 312a and 314a for inserting the vertical rod 100c.

Each of the walls 311 to 314 of the bracket 310 are integrally formed using metal, and a substantially rectangular parallelepiped cavity S is formed in the bracket 310 and is surrounded by each of the walls 311 to 314. In this cavity S, a first tightening member 330 and a second tightening member 340 are housed through an opening part formed on the housing side of the percussion instrument.

A pair of fastening portions 315 that protrude on two sides in the tightening direction of the tightening bolt 20 are integrally formed on the pair of side walls 313, and by screwing this fastening portions 315 to the housing of the percussion instrument, the bracket 310 and each of the tightening members 330 and 340 are assembled to the housing of the percussion instrument.

The first tightening member 330 is a resin part for tightening the horizontal rod 100a, and the second tightening member 340 is a metal part for tightening the horizontal rod 100b and the vertical rod 100c.

The first tightening member 330 includes a first tightening portion 331 having an inner circumferential surface 331a with a circular cross section corresponding to the insertion hole 311a. Thus, when the horizontal rod 100a (see FIG. 9A) is inserted through the insertion hole 311a, the horizontal rod 100a is held by the inner circumferential surface 331a of the first tightening portion 331. It is noted that, although not shown in the drawings, the insertion of the horizontal rod 100a toward the first tightening portion 331 is stopped when it comes into contact with the housing of the percussion instrument (not shown). First, the structure for tightening this horizontal rod 100a by the first tightening portion 331 will be described with reference to FIG. 8A, FIG. 8B, and FIG. 9A.

As shown in FIG. 8A, FIG. 8B, and FIG. 9A, a slit 331b is formed in the upper end portion of the first tightening portion 331, partially dividing the first tightening portion 331 in a circumferential direction (the direction around the inner circumferential surface 331a). The slit 331b is a crack extending across two ends in the axial direction of the inner circumferential surface 331a of the first tightening portion 331, and the formation of this slit 331b enables the first tightening portion 331 formed in a substantially C-shape to be elastically deformed (deformed to narrow the width of the slit 331b).

A side surface 331c of the first tightening portion 331 facing the tightening bolt 20 side is formed in an arc shape corresponding to the inner circumferential surface 331a of the first tightening portion 331 (centered on the central axis of the inner circumferential surface 331a). A partition wall 316 supporting the side surface 331c of the first tightening portion 331 rises upward from the lower wall 312 of the bracket 310. A side surface 316a (see FIG. 8B) of the partition wall 316 facing the first tightening portion 331 side is a curved surface that runs along the side surface 331c of the first tightening portion 331.

A recessed portion 333 is formed on the upper end side of the side surface 331c of the first tightening portion 331. The recessed portion 333 is formed in a groove shape extending across two ends of the side surface 331c of the first tightening portion 331 in the insertion direction of the horizontal rod 100a (the direction perpendicular to the paper surface of FIG. 9A).

The recessed portion 333 has a curved shape that protrudes toward the opposite side to the tightening bolt 20 (the right side in FIG. 9A), and a projecting portion 341 of the second tightening member 340 that extends between the upper wall 314 and the partition wall 316 is fitted into this recessed portion 333. The tip surface of the projecting portion 341 has a curved shape that runs along the recessed portion 333 (protrudes toward the recessed portion 333 side), and the second tightening portion 342 extending downward is integrally formed at the base end of the projecting portion 341 (the end portion on the tightening bolt 20 side).

A female screw hole 13a is formed in the side wall 313 of the bracket 310 facing the second tightening portion 342, and a recessed portion 242c for inserting the shaft portion 21 of the tightening bolt 20 is formed on the side surface of the second tightening portion 342 facing the tightening bolt 20. Thus, the second tightening member 340 slides toward the first tightening portion 331 side by pushing in the second tightening portion 342 by the tightening force of the tightening bolt 20.

By sliding the second tightening member 340, the recessed portion 333 is pushed in by the projecting portion 341, and the first tightening portion 331 elastically deforms to reduce the diameter of the inner circumferential surface 331a (to narrow the width of the slit 331b) (see FIG. 9A). The horizontal rod 100a is tightened by the elastic deformation of this first tightening portion 331, and the horizontal rod 100a is fixed to the bracket 310.

Next, a configuration for tightening the horizontal rod 100b and the vertical rod 100c by the second tightening portion 342 will be described.

As shown in FIG. 8A, FIG. 8B, and FIG. 9B, the second tightening portion 342 and the partition wall 316 face each other across the insertion hole 311b, and a groove 42a is formed on the side surface of the second tightening portion 342 facing the partition wall 316. Further, a groove 316b having a projecting arc shape is formed on the side surface of the partition wall 316 facing the second tightening portion 342, opposite to the groove 42a. The groove 316b extends in the insertion direction of the horizontal rod 100b (the direction perpendicular to the paper surface of FIG. 9B) and is connected to the inner circumferential surface of the insertion hole 311b.

Thus, by tightening the tightening bolt 20 with the horizontal rod 100b inserted into the insertion hole 311b, the horizontal rod 100b is tightened by the insertion hole 311b, the groove 42a of the second tightening portion 342, and the groove 316b of the partition wall 316.

As shown in FIG. 9A, the second tightening member 340 and the partition wall 316 are formed with grooves 346 and 316c for passing the vertical rod 100c therethrough. The groove 346 extends upwardly and downwardly and is continuous with the insertion hole 312a of the lower wall 312 and the insertion hole 314a of the upper wall 314. Further, the groove 316c of the partition wall 316 extends upwardly and downwardly and is continuous with the insertion hole 12a of the lower wall 312.

Thus, although not shown in the drawings, the vertical rod 100c inserted into the insertion hole 314a through the insertion hole 312a and the grooves 346 and 316c is tightened by the insertion holes 312a and 314a and the grooves 346 and 316c.

In this way, also in this embodiment, the horizontal rods 100a and 100b and the vertical rod 100c may be tightened by the first tightening portion 331 and the second tightening portion 342 of each of the tightening members 330 and 340. As a result, the percussion instrument may be supported by the two horizontal rods 100a and 100b that extend in the same direction (horizontal direction) and have different diameters, while the percussion instrument may also be supported by the vertical rod 100c that extends in a direction different from that of the horizontal rods 100a and 100b. Thus, the versatility of the percussion instrument may be improved.

In addition, since the grooves 42a and 346 of the second tightening portion 342 are formed at positions overlapping the shaft portion 21 of the tightening bolt 20 in the tightening direction of the tightening bolt 20 (see FIG. 9A), the tightening force of the tightening bolt 20 is easily transmitted to the horizontal rod 100b and the vertical rod 100c. Thus, each of the rods 100b and 100c may be firmly fixed to the bracket 310.

In addition, since the horizontal rod 100a is tightened by utilizing the elastic deformation of the first tightening portion 331, by loosening the tightening bolt 20, the elastic restoring force of the first tightening portion 331 may be utilized to return each of the tightening members 330 and 340 to their initial positions (the state before the tightening bolt 20 is tightened). Thus, the first tightening portion 331 and the second tightening portion 342 may be suppressed from interfering with (getting caught on) the insertion of the each of the rods 100a to 100c.

Further, the first tightening member 330 having the first tightening portion 331 and the second tightening member 340 having the second tightening portion 342 are separate parts, and in this configuration, the first tightening portion 331 is elastically deformed by the sliding displacement of the second tightening member 340. Thus, unlike the case where the first tightening portion 331 and the second tightening portion 342 are integrally formed, the second tightening portion 342 may be suppressed from accompanying the elastic deformation of the first tightening portion 331. As a result, the second tightening portion 342 (second tightening member 340) becomes more easily displaced along the tightening direction of the tightening bolt 20, so that the tightening force of the tightening bolt 20 is more easily transmitted to the horizontal rod 100b and the vertical rod 100c.

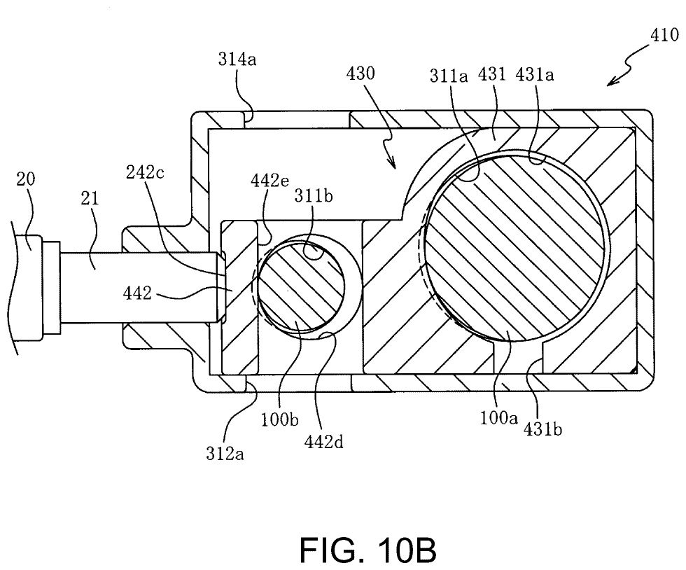

Next, the fourth embodiment will be described with reference to FIG. 10A and FIG. 10B. FIG. 10A is a cross-sectional view of the bracket 410 of the fourth embodiment, and FIG. 10B is a cross-sectional view of the bracket 410 showing a state in which the horizontal rods 100a and 100b are tightened by the first tightening portion 431 and the second tightening portion 442. It is noted that FIG. 10A and FIG. 10B shows a cross section of the bracket 410 cut along a plane corresponding to that in FIG. 9.

Further, although FIG. 10B shows a state in which each of the horizontal rods 100a and 100b are tightened by the first tightening portion 431 and the second tightening portion 442, respectively, when the percussion instrument is actually supported on a drum set, either one of the rods is tightened by the first tightening portion 431 or the second tightening portion 442.

As shown in FIG. 10A, the bracket 410 of the fourth embodiment has the same configuration as the bracket 310 of the third embodiment, except for the point that the partition wall 316 (see FIG. 9) is omitted. Thus, similar to the bracket 310 of the third embodiment, the bracket 410 is formed with insertion holes 311a, 311b, 312a, and 314a for inserting each of the rods 100a to 100c therein.

The tightening member 430 is a resin part for tightening each of the rods 100a to 100c. The tightening member 430 includes a cylindrical first tightening portion 431 having an inner circumferential surface 431a with a circular cross section corresponding to the horizontal rod 100a (insertion hole 311a), and a slit 431b is formed in the lower end portion of the first tightening portion 431, partially dividing the first tightening portion 431 in a circumferential direction (the direction around the inner circumferential surface 431a). The slit 431b is a crack extending across two ends in the axial direction of the inner circumferential surface 431a of the first tightening portion 431, and the formation of this slit 431b enables the first tightening portion 431 formed in a substantially C-shape to be elastically deformed (deformed to narrow the width of the slit 431b).

The first tightening portion 431 is integrally formed with a second tightening portion 442 for tightening the horizontal rod 100b. The first tightening portion 431 and the second tightening portion 442 are both formed in a substantially rectangular parallelepiped shape, and the tightening member 430 is housed inside the bracket 410.

When the tightening member 430 is housed in the bracket 410, the shaft portion 21 of the tightening bolt 20 and the second tightening portion 442 face each other. A recessed portion 242c is formed on the side surface of the second tightening portion 442 facing the tightening bolt 20 side, and the tightening force of the tightening bolt 20 acts on the second tightening portion 442. As a result, the entire tightening member 440 is elastically deformed so as to be compressed in the tightening direction of the tightening bolt 20, thereby elastically deforming the cylindrical first tightening portion 431 so as to reduce the diameter of the inner circumferential surface 431a (to narrow the width of the slit 431b).

Thus, as shown in FIG. 10B, by tightening the tightening bolt 20 with the horizontal rod 100a inserted into the insertion hole 311a and the first tightening portion 431, the horizontal rod 100a is tightened by the elastic deformation of the first tightening portion 431.

It is noted that, in this embodiment, although the diameter of the inner circumferential surface 431a of the first tightening portion 431 is formed to be larger than the diameter of the insertion hole 311a, and the horizontal rod 100a is sandwiched between the insertion hole 311a and the inner circumferential surface 431a of the first tightening portion 431 by elastic deformation of the first tightening portion 431, it is of course possible to form the inner circumferential surface 431a of the first tightening part 431 with a diameter smaller than the diameter of the insertion hole 311a.

Further, as shown in FIG. 10B, the second tightening portion 442 is formed with a through hole 442d, which is continuous with the insertion hole 311b (extending in the insertion direction of the horizontal rod 100b). Thus, when the tightening force of the tightening bolt 20 acts on the second tightening portion 442, the second tightening portion 442 is elastically deformed so as to slightly narrow the through hole 442d, and in accordance with the elastic deformation of the first tightening portion 431, the second tightening portion 442 performs sliding displacement.

Thus, by tightening the tightening bolt 20 with the horizontal rod 100b inserted into the insertion hole 311b, the horizontal rod 100b is tightened by being sandwiched between the insertion hole 311b and the through hole 442d of the second tightening portion 442.

Further, in the second tightening portion 442, a through hole 442e is formed at a position overlapping the insertion holes 312a and 314a in the up and down direction. Thus, although not shown in the drawings, the vertical rod 100c inserted into the insertion hole 314a through the insertion hole 312a and the through hole 442e is fixed to the bracket 410 by being tightened to the insertion holes 312a and 314a and the through hole 442e.

In this way, also in this embodiment, the horizontal rods 100a and 100b and the vertical rod 100c may be tightened by the first tightening portion 431 and the second tightening portion 442. As a result, the percussion instrument may be supported by the two horizontal rods 100a and 100b that extend in the same direction (horizontal direction) and have different diameters, while the percussion instrument may also be supported by the vertical rod 100c that extends in a direction different from that of the horizontal rods 100a and 100b. Thus, the versatility of the percussion instrument may be improved.

Further, since the through hole 442d and the through hole 442e of the second tightening portion 442 are formed at positions overlapping the shaft portion 21 of the tightening bolt 20 in the tightening direction of the tightening bolt 20, the tightening force of the tightening bolt 20 is easily transmitted to the horizontal rod 100b and the vertical rod 100c.

In addition, since the first tightening portion 431 and the second tightening portion 442 for tightening the horizontal rods 100a and 100b are integrally formed, the number of parts may be reduced, and the work of assembling the bracket 410 and the tightening member 430 to the percussion instrument is facilitated.

In addition, since the horizontal rod 100a is tightened by utilizing the elastic deformation of the first tightening portion 431, by loosening the tightening bolt 20, the elastic restoring force of the first tightening portion 431 may be utilized to return each of the tightening members 430 and 440 to their initial positions (the state before the tightening bolt 20 is tightened). Thus, the first tightening portion 431 and the second tightening portion 442 may be suppressed from interfering with (getting caught on) the insertion of each of the rods 100a to 100c.

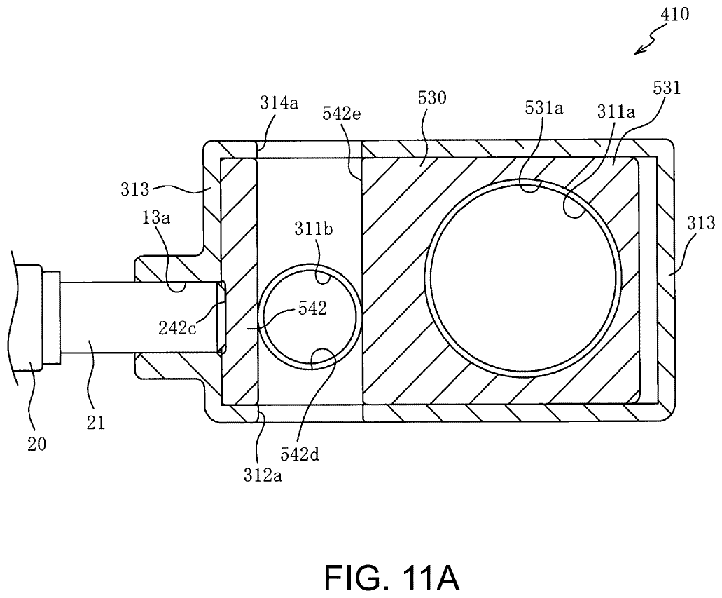

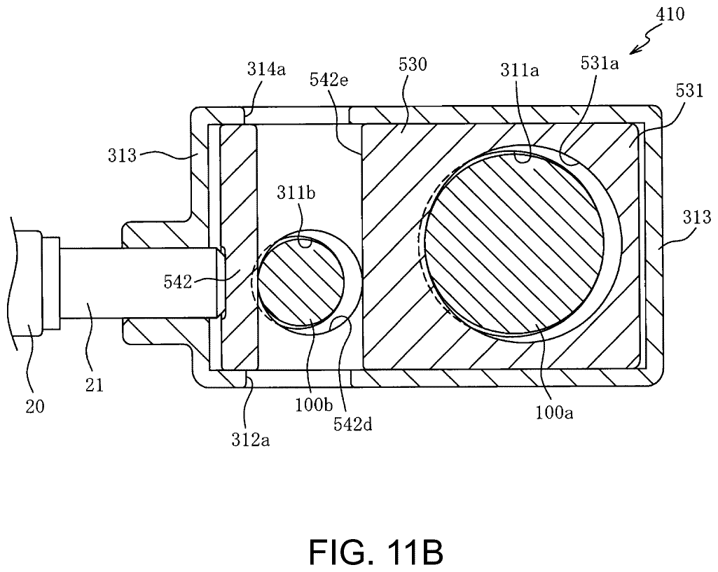

Next, the fifth embodiment will be described with reference to FIG. 11A and FIG. 11B. FIG. 11A is a cross-sectional view of the bracket 410 of the fifth embodiment, and FIG. 11B is a cross-sectional view of the bracket 410 showing a state in which the horizontal rods 100a and 100b are tightened by the first tightening portion 531 and the second tightening portion 542. It is noted that FIG. 11A and FIG. 11B shows a cross section of the bracket 410 cut along a plane corresponding to that in FIG. 10A and FIG. 10B.

Further, although FIG. 11B shows a state in which the horizontal rods 100a and 100b are tightened by the first tightening portion 531 and the second tightening portion 542, respectively, when the percussion instrument is actually supported on a drum set, either one of the rods is tightened by the first tightening portion 531 or the second tightening portion 542.

As shown in FIG. 11A, the tightening member 530 of the fifth embodiment is a metal or resin part formed in a rectangular parallelepiped shape that is long in the tightening direction of the tightening bolt 20. The bracket 410 with the tightening member 530 housed therein is screwed to the housing of the percussion instrument, whereby the bracket 410 and the tightening member 530 are assembled to the housing of the percussion instrument. In this assembled state, a gap is formed between the pair of side walls 313 of the bracket 410 and the tightening member 530, allowing the sliding displacement of the tightening member 530 in the tightening direction of the tightening bolt 20.

The tightening member 530 is integrally formed with the first tightening portion 531 having a through hole 531a with a circular cross section connected to the insertion hole 311a and the second tightening portion 542 having a through hole 542d with a circular cross section connected to the insertion hole 311b. A recessed portion 242c is formed on the side surface of the second tightening portion 542 facing the tightening bolt 20 side, and the tightening force of the tightening bolt 20 acts on the second tightening portion 542. As a result, the tightening member 530 performs sliding displacement along the tightening direction of the tightening bolt 20.

Thus, as shown in FIG. 11B, by tightening the tightening bolt 20 with the horizontal rod 100a inserted into the insertion hole 311a and the through hole 531a of the first tightening portion 531, the horizontal rod 100a is tightened by being sandwiched between the insertion hole 311a and the through hole 531a of the first tightening portion 531. Similarly, by tightening the tightening bolt 20 with the horizontal rod 100b inserted into the insertion hole 311b, the horizontal rod 100b is tightened by being sandwiched between the insertion hole 311b and the through hole 542d of the second tightening portion 542.

Further, the second tightening portion 542 is formed with a through hole 542e that extends upwardly and downwardly and connects to the insertion holes 312a and 314a. Thus, although not shown in the drawings, the vertical rod 100c inserted into the insertion hole 314a through the insertion hole 312a and the through hole 542e is fixed to the bracket 410 by being tightened to the insertion holes 312a and 314a and the through hole 542e.

In this way, also in this embodiment, the horizontal rods 100a and 100b and the vertical rod 100c may be tightened by the first tightening portion 531 and the second tightening portion 542. As a result, the percussion instrument may be supported by the two horizontal rods 100a and 100b that extend in the same direction (horizontal direction) and have different diameters, while the percussion instrument may also be supported by the vertical rod 100c that extends in a direction different from that of the horizontal rods 100a and 100b. Thus, the versatility of the percussion instrument may be improved.

Further, since the through hole 542d and the through hole 542e of the second tightening portion 542 are formed at positions overlapping the shaft portion 21 of the tightening bolt 20 in the tightening direction of the tightening bolt 20, the tightening force of the tightening bolt 20 is easily transmitted to the horizontal rod 100b and the vertical rod 100c. Thus, each of the rods 100b and 100c may be firmly fixed to the bracket 410.

In addition, since the first tightening portion 531 and the second tightening portion 542 for tightening the horizontal rods 100a and 100b are integrally formed, the number of parts may be reduced, and the work of assembling the bracket 410 and the tightening member 530 to the percussion instrument is facilitated.

Furthermore, since each of the rods 100a to 100c are tightened by the sliding displacement of the tightening member 530, compared to the case where the tightening member is elastically deformed, fatigue of the tightening member 530 may be suppressed.

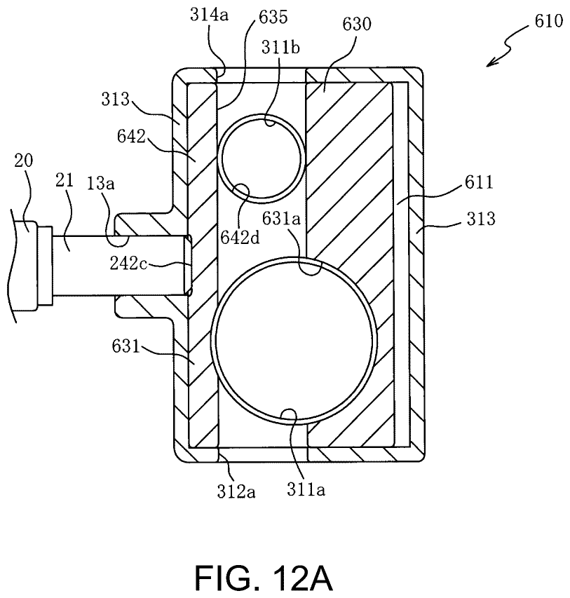

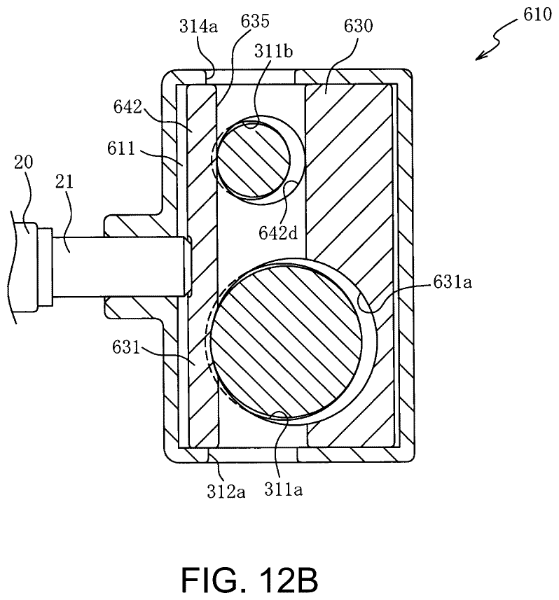

In this embodiment, the tightening member 530 is simply slidably held inside the bracket 410, but the disclosure is not limited thereto. For example, an elastic body such as a spring for returning the tightening member 530 to the initial position thereof may be provided between the tightening member 530 and the side walls 313 of the bracket 410. The same applies to the sixth embodiment (see FIG. 12A and FIG. 12B) described later.

Next, the sixth embodiment will be described with reference to FIG. 12A and FIG. 12B. FIG. 12A is a cross-sectional view of the bracket 610 of the sixth embodiment, and FIG. 12B is a cross-sectional view of the bracket 610 showing a state in which the horizontal rods 100a and 100b are tightened by the first tightening portion 631 and the second tightening portion 642. It is noted that FIG. 12A and FIG. 12B shows a cross section of the bracket 610 cut along a plane corresponding to that in FIG. 11A and FIG. 11B.

Further, although FIG. 12B shows a state in which the horizontal rods 100a and 100b are tightened by the first tightening portion 631 and the second tightening portion 642, respectively, when the percussion instrument is actually supported on a drum set, either one of the rods is tightened by the first tightening portion 631 or the second tightening portion 642.

As shown in FIG. 12A, the bracket 610 of the sixth embodiment has insertion holes 311a and 311b formed in line in the up and down direction in an outer circumferential wall 611, and the bracket 610 has the same configuration as the bracket 410 of the fifth embodiment except for the point that the outer shape of the bracket 610 is a rectangular parallelepiped that is long in the up and down direction.

The tightening member 630 is a metal or resin part formed into a rectangular parallelepiped shape that is long in the up and down direction. The bracket 610 with the tightening member 630 housed therein is screwed to the housing of the percussion instrument, whereby the bracket 610 and the tightening member 630 are assembled to the housing of the percussion instrument. In this assembled state, a gap is formed between the pair of side walls 313 of the bracket 610 and the tightening member 630, and the bracket 610 slidably holds the tightening member 630 in the tightening direction of the tightening bolt 20.

The tightening member 630 is integrally formed with the first tightening portion 631 having a through hole 631a with a circular cross section connected to the insertion hole 311a and the second tightening portion 642 having a through hole 642d with a circular cross section connected to the insertion hole 311b.

A recessed portion 242c is formed on the side surface of the tightening member 630 facing the tightening bolt 20 side, and the tightening force of the tightening bolt 20 acts on the tightening member 630. As a result, the tightening member 630 performs sliding displacement along the tightening direction of the tightening bolt 20.

Thus, as shown in FIG. 12B, by tightening the tightening bolt 20 with the horizontal rod 100a inserted into the insertion hole 311a and the through hole 631a of the first tightening portion 631, the horizontal rod 100a is tightened by being sandwiched between the insertion hole 311a and the through hole 631a of the first tightening portion 631. Similarly, by tightening the tightening bolt 20 with the horizontal rod 100b inserted into the insertion hole 311b, the horizontal rod 100b is tightened by being sandwiched between the insertion hole 311b and the through hole 642d of the second tightening portion 642.

Further, the tightening member 630 has a through hole 635 that intersects with each of the through holes 631a and 642d of the first tightening portion 631 and the second tightening portion 642, and this through hole 635 extending upwardly and downwardly is connected to the insertion holes 312a and 314a. Thus, although not shown in the drawings, the vertical rod 100c inserted into the insertion hole 314a through the insertion hole 312a and the through hole 635 is fixed to the bracket 610 by being tightened to the insertion holes 312a and 314a and the through hole 635.

In this way, also in this embodiment, the horizontal rods 100a and 100b and the vertical rod 100c may be tightened by the first tightening portion 631 and the second tightening portion 642. As a result, the percussion instrument may be supported by the two horizontal rods 100a and 100b that extend in the same direction (horizontal direction) and have different diameters, while the percussion instrument may also be supported by the vertical rod 100c that extends in a direction different from that of the horizontal rods 100a and 100b. Thus, the versatility of the percussion instrument may be improved.

In addition, since the first tightening portion 631 and the second tightening portion 642 for tightening the horizontal rods 100a and 100b are integrally formed, the number of parts may be reduced, and the work of assembling the bracket 610 and the tightening member 630 to the percussion instrument is facilitated.

Furthermore, since each of the rods 100a to 100c are tightened by the sliding displacement of the tightening member 630, compared to the case where the tightening member is elastically deformed, fatigue of the tightening member 630 may be suppressed.

The above description has been given based on the above embodiment, but the disclosure is not limited to the above embodiments, and it may be easily inferred that various improvements and modifications are possible within the range that does not deviate from the spirit of the disclosure.

In the above embodiments, the percussion instruments 1 and 201 are electronic percussion instruments, but the disclosure is not necessarily limited thereto. For example, the above-mentioned configuration of each of the embodiments may be applied to the case where an acoustic percussion instrument (drum) is supported on each of the rods 100a to 100c.

In each of the above embodiments, the case where two types of horizontal rods 100a and 100b extending in the horizontal direction and having different diameters are tightened by the first tightening portions 31, 331, 431, 531, and 631 and the second tightening portions 42, 242, 342, 442, 542, and 642 (hereinafter, simply referred to as the “tightening portion.”), but the disclosure is not necessarily limited thereto. It may also be configured such that two types of rods extending in a vertical direction (or in a direction inclined relative to the vertical direction) and having different diameters are tightened by the tightening portion. In this configuration, the orientation of the tightening portion may be changed according to the direction in which the rod extends.

Also, instead of using two types of rods, three or more types of rods extending in the same direction may be tightened by the tightening portion. As an example of such a configuration, a configuration is illustrated in which an insertion hole for inserting a third type of rod is added below the insertion hole 11b of the bracket of the first and second embodiments, the second tightening portions 42 and 242 are extended downward, and the third type of rod is tightened by the extended part. As another example, a configuration is illustrated in which, in addition to the insertion holes 311a and 311b of the fifth and sixth embodiments, an insertion hole for inserting a third type of rod is added, and a through hole connected to the insertion hole is formed in the tightening members 530 and 630.

In each of the above embodiments, although a case has been described in which the tightening portion is formed at a position overlapping the shaft portion 21 of the tightening bolt 20 in the tightening direction of the tightening bolt 20, in the same direction, the tightening portion may be formed at a position that does not overlap the shaft portion 21 of the tightening bolt 20.

In the above-mentioned first embodiment, although a case has been described in which the protrusion 33 is formed in the vicinity of the slit 31b, the vicinity of the slit 31b is the area below the center C (slit 31b side) of the line segment connecting the lower end of the virtual circle V (the center of the slit 31b in the circumferential direction of the inner circumferential surface 31a) and the central axis O shown in FIG. 5B.

In the above first embodiment, a pair of protrusions 33 are formed in line in the insertion direction of the horizontal rod 100b (horizontal rod 100a), but this is not necessarily limited thereto. For example, the protrusions 33 may be formed across two ends of the first tightening portion 31 in the insertion direction of the horizontal rod 100b, or three or more protrusions 33 may be formed in the insertion direction of the horizontal rod 100b.

In the above-mentioned first and second embodiments, the case where the horizontal rod 100b is sandwiched between the second tightening portions 42 and 242 and the edges of the insertion holes 11b and 14a and the case where the vertical rod 100c is sandwiched between the second tightening portions 42 and 242 and the edges of the insertion holes 8b and 12a are described, but the disclosure is not necessarily limited thereto. For example, the horizontal rod 100b and the vertical rod 100c may also be tightened by the second tightening portion 42 and the leg portion 34.

What is claimed is:

1. A percussion instrument, supportable on a first rod and a second rod having a smaller diameter than the first rod, the percussion instrument comprising:
a housing; a bracket, provided on an outer surface of the housing; a tightening bolt, tightened toward a cavity inside the bracket; and a tightening portion, elastically deformed or performing sliding displacement inside the bracket by a tightening force of the tightening bolt,
the bracket comprising a first insertion hole into which the first rod is insertable and a second insertion hole into which the second rod is insertable in a direction the same as an insertion direction of the first rod into the first insertion hole, and
the tightening portion is at least configured by a first tightening portion capable of tightening the first rod inserted into the first insertion hole and a second tightening portion capable of tightening the second rod inserted into the second insertion hole.

2. The percussion instrument according to claim 1, wherein
the first tightening portion is formed in a cylindrical shape having an inner circumferential surface connected to the first insertion hole,
a slit is formed in the first tightening portion and partially divides the first tightening portion in a circumferential direction, and
the first tightening portion is elastically deformed by a tightening force of the tightening bolt toward the second tightening portion to tighten the first rod.

3. The percussion instrument according to claim 2, comprising a first tightening member having the first tightening portion and a second tightening member having the second tightening portion,
wherein the first tightening portion is elastically deformed by a sliding displacement of the second tightening member due to a tightening force of the tightening bolt.

4. The percussion instrument according to claim 3, wherein the second tightening portion is formed at a position overlapping a shaft portion of the tightening bolt in a tightening direction of the tightening bolt.

5. The percussion instrument according to claim 3, wherein
the first tightening member comprises a protrusion protruding from an outer circumferential surface of the first tightening portion, and
the protrusion provided on a displacement locus of sliding displacement of the second tightening member is pushed by the second tightening member.

6. The percussion instrument according to claim 5, wherein
a plurality of the protrusions are formed in line in an insertion direction of the first rod, and
the second tightening portion protrudes from between the plurality of the protrusions to tighten the second rod.

7. The percussion instrument according to claim 1, wherein
the bracket comprises a third insertion hole into which a third rod is insertable in a direction different from an insertion direction of the first rod into the first insertion hole, and
the second tightening portion is capable of tightening the third rod inserted into the third insertion hole.

8. The percussion instrument according to claim 7, wherein the second tightening portion is formed at a position overlapping a shaft portion of the tightening bolt in a tightening direction of the tightening bolt.

9. The percussion instrument according to claim 1, wherein the second rod is tightened by an inner circumferential surface of the second insertion hole and the second tightening portion.

10. The percussion instrument according to claim 1, wherein the first tightening portion and the second tightening portion are integrally formed.

11. The percussion instrument according to claim 1, wherein
the bracket slidably holds the first tightening portion and the second tightening portion in a cavity inside the bracket, and
the first rod and the second rod are tightened by sliding displacement of the first tightening portion and the second tightening portion.

12. A percussion instrument, supportable on a first rod and a second rod having a smaller diameter than the first rod, the percussion instrument comprising:
a housing; a bracket, provided on an outer surface of the housing; a tightening bolt, tightened toward a cavity inside the bracket; and a tightening portion, elastically deformed or performing sliding displacement inside the bracket by a tightening force of the tightening bolt,
the bracket comprising a first insertion hole into which the first rod is insertable and a second insertion hole into which the second rod is insertable, and
the tightening portion is at least configured by a first tightening portion capable of tightening the first rod inserted into the first insertion hole and a second tightening portion capable of tightening the second rod inserted into the second insertion hole.

13. The percussion instrument according to claim 12, wherein
the first tightening portion is formed in a cylindrical shape having an inner circumferential surface connected to the first insertion hole,
a slit is formed in the first tightening portion and partially divides the first tightening portion in a circumferential direction, and
the first tightening portion is elastically deformed by a tightening force of the tightening bolt toward the second tightening portion to tighten the first rod.

14. The percussion instrument according to claim 13, comprising a first tightening member having the first tightening portion and a second tightening member having the second tightening portion,
wherein the first tightening portion is elastically deformed by a sliding displacement of the second tightening member due to a tightening force of the tightening bolt.

15. The percussion instrument according to claim 14, wherein the second tightening portion is formed at a position overlapping a shaft portion of the tightening bolt in a tightening direction of the tightening bolt.

16. The percussion instrument according to claim 14, wherein
the first tightening member comprises a protrusion protruding from an outer circumferential surface of the first tightening portion, and
the protrusion provided on a displacement locus of sliding displacement of the second tightening member is pushed by the second tightening member.

17. The percussion instrument according to claim 16, wherein
a plurality of the protrusions are formed in line in an insertion direction of the first rod, and
the second tightening portion protrudes from between the plurality of the protrusions to tighten the second rod.

18. The percussion instrument according to claim 12, wherein
the bracket comprises a third insertion hole into which a third rod is insertable in a direction different from an insertion direction of the first rod into the first insertion hole, and
the second tightening portion is capable of tightening the third rod inserted into the third insertion hole.

19. A rod tightening method for a rod in a percussion instrument being supportable on a first rod and a second rod having a smaller diameter than the first rod, the percussion instrument comprising:
a housing; a bracket, provided on an outer surface of the housing; a tightening bolt, tightened toward a cavity inside the bracket; and a tightening portion, elastically deformed or performing sliding displacement inside the bracket by a tightening force of the tightening bolt,
the bracket comprising a first insertion hole into which the first rod is insertable and a second insertion hole into which the second rod is insertable,
wherein the tightening portion is at least configured by a first tightening portion and a second tightening portion, and
the first rod inserted into the first insertion hole is tightened by the first tightening portion, while the second rod inserted into the second insertion hole is tightened by the second tightening portion.

20. The method according to claim 19, wherein the second rod is insertable in a direction the same as an insertion direction of the first rod into the first insertion hole.
